(19) United States
(12) Patent Application Publication
(10) Pub. No.: US 2013/0055200 A1
(43) Pub. Date: Feb. 28, 2013

(54) APPLICATION INTERFACE FOR OBJECT BUILD INFORMATION

(71) Applicants: Wilco Gerardus Bernardus Bauwer, Seattle, WA (US); Brian F. Chapman, Redmond, WA (US)

(72) Inventors: Wilco Gerardus Bernardus Bauwer, Seattle, WA (US); Brian F. Chapman, Redmond, WA (US)

(73) Assignee: MICROSOFT CORPORATION, Redmond, WA (US)

(21) Appl. No.: 13/221,713

(22) Filed: Aug. 30, 2011

(51) Int. Cl. G06F 9/44

(52) U.S. Cl. 717/108

(57) ABSTRACT

The formulation of an application object in a memory of a computing system. A system level of the computing system determines that an application object is to be created, but also determines that at least part of the object build information to be used to create the application object is available at an application running on the computing system. The system then interfaces with the application through an interface to cause the application object to be created in the memory using the object build information that is available at the application. As an example, the system level may be parsing a hierarchically structured document that defines various objects of a program.

### BACKGROUND

Documents are often drafted in a hierarchically structured way in which portions of the document represent nodes in a hierarchy, and there is some convention for recognizing interrelationships between the nodes. Organization into some hierarchical structure is helpful as it enables data to be more effectively organized and identified within the document. That is one of the driving motivations for the development of eXtensible Markup Language or XML.

There have even been standards for the definition of application programs based on hierarchically structured documents. One such standard is referred to as eXtensible Application Markup Language (XAML), but builds upon the XML standards.

During runtime, a XAML parser interprets XAML documents, and causes corresponding objects to be instantiated in memory. Entire object hierarchies may be constructed by interpreting XAML documents. The XAML parser uses object build information to cause the objects to be constructed. Such object build information may include, for example, type constructors, property (or event) accessors, and other type information.

### BRIEF SUMMARY

At least one embodiment described herein relates to the formulation of an application object in a memory of a computing system. A computing system determines that an application object is to be created. The system then interfaces with the application through an interface to cause the application object to be created in the memory using the object build information that is available at the application. As an example, the system level may parse a hierarchically structured document that defines various objects of a program. The document may include hierarchical declarations that define various objects of a program and their relationships.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features can be obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1 illustrates an example computing system that may be used to employ embodiments described herein;

FIG. 2 illustrates an environment in which a system may use an application interface to build an object defined in the application;

FIG. 3 illustrates a flowchart of a method for creating objects in a memory of a computing system in which some objects are system objects, and some are application objects;

FIG. 4 illustrates an environment in which the application may be constructed in a manner that it is able to implement the interface of FIG. 2; and

FIG. 5 illustrates how the object build information may be acquired recursively by the application interface support code from another second level of code through another instance of the application interface.

### DETAILED DESCRIPTION

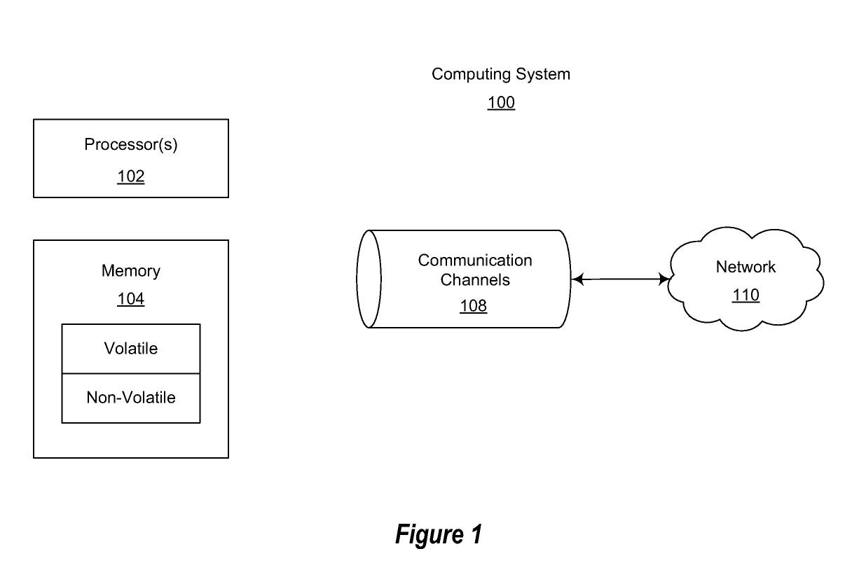

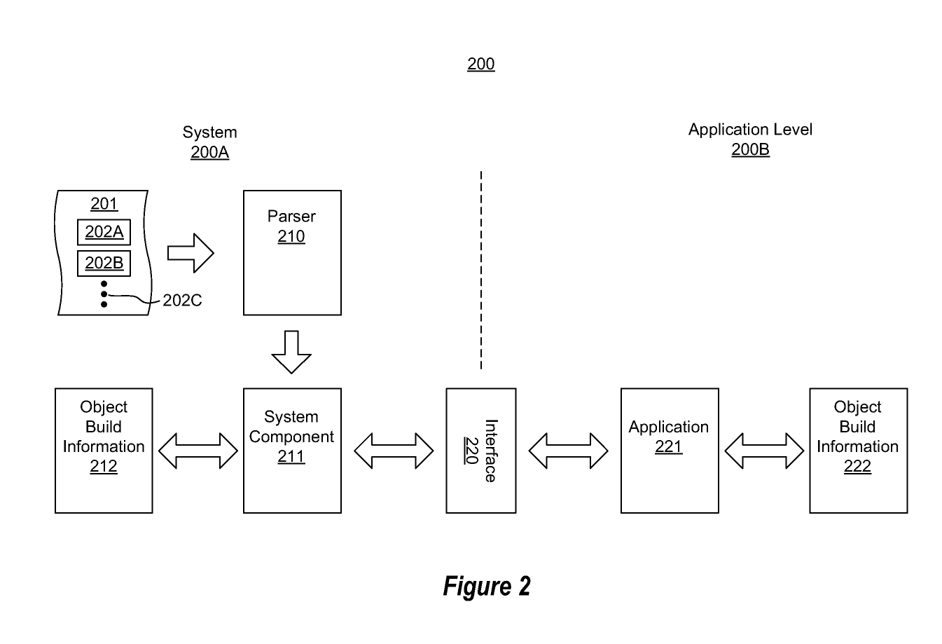

In accordance with embodiments described herein, the formulation of an application object in a memory of a computing system is described. A system level of the computing system determines that an application object is to be created. The system then interfaces with the application through an interface to cause the application object to be created in the memory using the object build information that is available at the application. As an example, the system level may parse a hierarchically structured document that defines various objects of a program, including the application object. First, some introductory discussion regarding computing systems will be described with respect to FIG. 1. Then, the embodiments of the formulation of the application object will be described with respect to FIGS. 2 through 5.

First, introductory discussion regarding computing systems is described with respect to FIG. 1. Computing systems are now increasingly taking a wide variety of forms. Computing systems may, for example, be handheld devices, appliances, laptop computers, desktop computers, mainframes, distributed computing systems, or even devices that have not conventionally been considered a computing system. In this description and in the claims, the term “computing system” is defined broadly as including any device or system (or combination thereof) that includes at least one physical and tangible processor, and a physical and tangible memory capable of having thereon computer-executable instructions that may be executed by the processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well. As used herein, the term “module” or “component” can refer to software objects or routines that execute on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. An example of such an operation involves the manipulation of data. The computer-executable instructions (and the manipulated data) may be stored in the memory 104 of the computing system 100. Computing system 100 may also contain communication channels 108 that allow the computing system 100 to communicate with other message processors over, for example, network 110.

Embodiments described herein may comprise or utilize a special purpose or general-purpose computer including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer. In this description and in the claims, a “computer program product” includes one or more computer storage media having computer-executable instructions thereon that, when executed by the one or more processors of the computing system, perform the function of the computer program product.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

FIG. 2 illustrates an environment 200 in which the principles described herein may operate. The environment 200 may be formulated in, for example, the computing system 100 of FIG. 1. The environment 200 includes a system level 200A and an application level 200B. The system level 200A may be, for example, the operating system of the computing system 100, whereas the application level 200B may include one or more applications that may be supported by the operating system. For instance, the application level 200B includes an application 221 that is executing on the computing system using the system level 200A as support.

Within the system level 200A, a parser 210 accesses a hierarchically structured document 201 that defines at least one system object 202A and at least one application object 202B. Although the definition for only one system object and one application object are illustrated as being included within the hierarchically structured document, the ellipses 202C represent that there may be additional system and/or application objects defined within the hierarchically structured document 201.

The hierarchically structured document 201 may include, for example, multiple declarations, in which case the system object definition 202A may be in the form of one or more declarations, and the application object definition 202B may also be in the form of one or more declarations. As an example, the hierarchically structured document 201 may be, for example, an eXtensible Markup Language (XML) document. In particular eXtensible Application Markup Language (XAML) is a format that represents a type of XML document in which an application program may be defined. In such a document, various declarations are used to define various objects of the application defined by the XAML document. In addition, the relationships between those objects are defined such that the XAML document may define an entire object tree.

As the parser 210 parses the document 201, the parser may encounter definitions for system objects. System objects are objects for which the system level 200A has sufficient object build information 212 to be able to build the system object in memory. “Building” an object in memory includes creating an object instance of an appropriate type, populating that instance with initial property values, and relating the object instance with other object instances (if and as appropriate given the application definition).

Thus, as a system object definition is encountered by the parser 210, the parser passes information regarding that definition to a system component 211, which then accesses the system-level object build information 212 in order to create the system object in the memory of the computing system. Examples of such object build information includes one or more of the following for each system object: 1) a type constructor, a property accessor, an event accessor, a base type for type compatibility checks, knowledge of whether the type is a collection to determine if a value is added to a property, and so forth.

A type constructor is code that actually creates an instance of an object of a particular type. The type constructor may also perhaps initialize one or more of the property values, although not required.

A property accessor is code that sets property values of an instantiated object. Those property values may have been previous set to a default value during instantiation, or perhaps were not previously set to a value at all.

An event accessor is code that populates event properties, such as the type of event that would be a trigger and/or a function that would be called in the case of such a trigger.

In accordance with the principles described herein, rather than being limited to system object types, whose object build information is accessible at the system level 200A, the declaration may also define application objects as well, where at least some of the object build information is to be accessed from an application through an interface. For instance, in FIG. 2, when the system component 211 receives information regarding an application object to be built, the system component 211 will determine that it does not have sufficient object build information to create the application object in memory. Accordingly, the system component 211 may interface with a running application 221 through the interface 220.

The application 221 has access to additional object build information 222. Again, the object build information 222 may include, for example, one or more of the following for each system object: 1) a type constructor, a property accessor, an event accessor, a base type for type compatibility checks, knowledge of whether the type is a collection to determine if a value is added to a property, and so forth.

The interface 220 implements methods for the instantiation of such application objects of particular types supported by the application 221. The interface 220 may also implement methods for getting and setting property values. The methods may build the application object instances themselves. However, in an approach described in further detail hereinafter, the method just reports the object build information to the system component 211 through the interface 220, so that the system component 211 may build the application object in memory. In the latter case, the system component 211 may store such object build information and thus become part of system object build information 212. This effectively converts the application type to a system type, since the system-level 200A now contains the object build information that is used to build an object of that type in memory.

Conventional parsers of hierarchically structured declarative documents (such as XAML in particular) have created system objects in which the object build information was included in the system-level itself. For instance, in conventional products, the application binaries (e.g., the .exe or .dll file) included information describing all the types in the application using Common Intermediate Language (CIL), a binary format standard. However, in accordance with the principles described herein, at runtime, as an object tree is being constructed, if an application object is encountered, the system may communicate through an interface to an existing running application to obtain the object build information directly. This is helpful for situations in which build information cannot be inferred within the system alone at runtime.

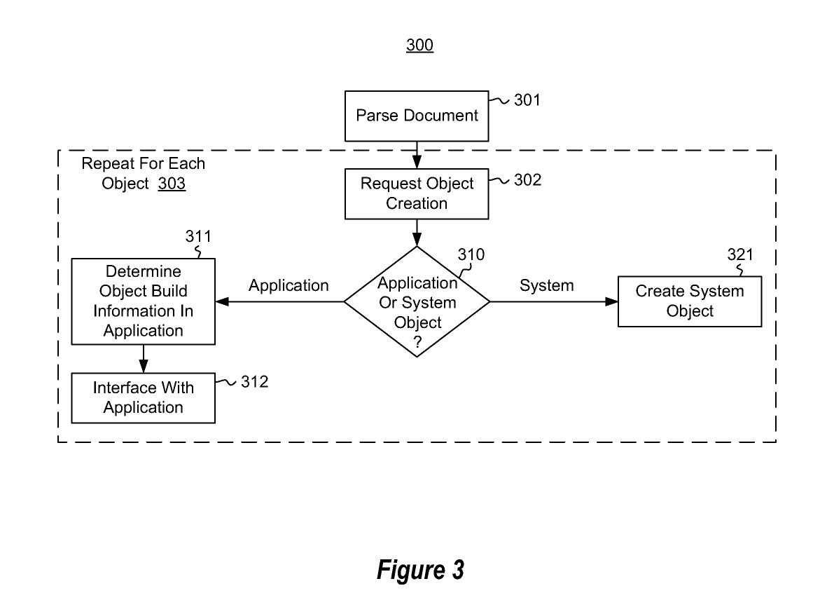

FIG. 3 illustrates a flowchart of a method 300 for creating objects in a memory of a computing system. As an example, the objects may be created in the memory 104 of the computing system. The method 300 may be executed in the context of the environment 200 of FIG. 2. Accordingly, the method 300 of FIG. 3 will now be described with frequent reference to the environment 200 of FIG. 2.

The method 300 is initiated upon the system parsing a hierarchically structured document (act 301) that defines multiple objects that are to be created in the memory. Referring to FIG. 2, the parser 210 parses the document 201. The remainder 303 of the method 300 may be performed for each object definition encountered in the document.

Note that the parser 210 itself may perform the function of the system component 211, as they need not be separate components. However, in the illustrated embodiment, the system component 211 receives a request from the parser 210 to create the defined object (act 302). The manner of creating the object may differ depending on whether the object is a system object or an application object (decision block 310).

If it is determined that the object to be created is an application object (“Application” in decision block 310), then it is likewise determined that at least part of object build information to be used to create the application object is available at an application (act 311), or at least it is determined that the system does not have sufficient object building information to create the object. It may be that, for example, some of the object build information is available at the system level 200A, and some available at the application level 200B. Alternatively, it may be that the application 221 provides all of the object build information, in which case the object build information 212 at the system level 200A need not include any object build information for that application object.

In the case of an application object (“Application” in decision block 310), the system then interfaces with the application through an interface to cause the application object to be created using the at least part of the object build information that is available at the application (312). For instance, in FIG. 2, the system component 211 interfaces with the application 221 through the interface 220. The object build information for the application is provided to the system through the interface so that the system can create the application object in memory.

If, on the other hand, the object to be created is a system object (“System Object” in decision block 310), then the system may create the system object using object build information that is already available to the system outside of the application (act 321).

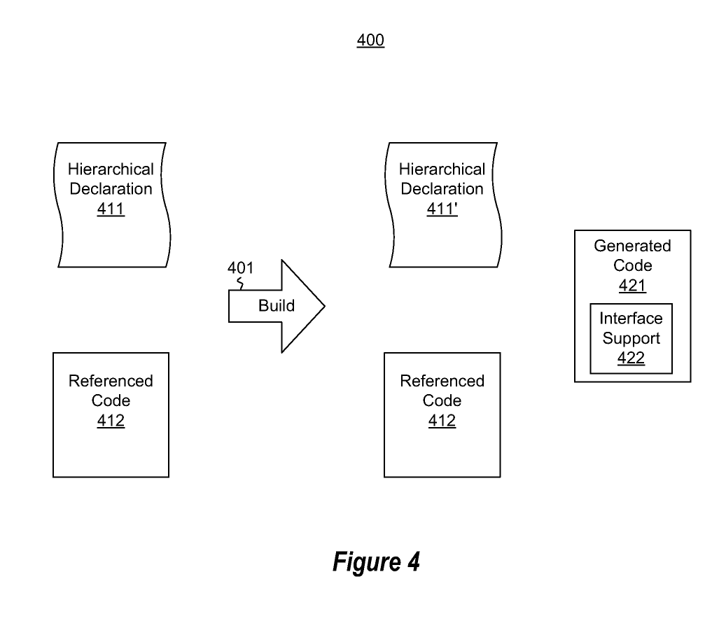

FIG. 4 illustrates an environment 400 in which the application 221 may be constructed in a manner that it is able to 1) implement the interface 220 (i.e., understand the methods invoked by the system through the interface 220, 2) perform appropriate processing to acquire the object build information for the application object, and 3) provide that object build information through the interface 220 (or create the object based on that object build information). Note that the application 221 is built previous to the parsing of the document 201 to create an object tree, since the application 221 is already executing when the document 201 is being parsed by parser 210.

After the application 221 has been authored, the application consists of a set of hierarchically structured declarations 411 (e.g., the XAML document itself), as well as referenced code 412. The referenced code includes the object code referred to in the declarations. This initial set is then put through a build process 401 in which there is additional generated code 421. This additional generated code includes interface support code 422, which includes the additional functionality that the application is to perform in order to implement the interface 220 and respond to function calls placed through the interface 220. Thus, when the system component 211 places function calls to the interface 220, it is really the compiled and executed form of the interface support code 422 that responds. As a side note, during this build 401, there may be a slight altering of the hierarchical declarations 411 thus generating slightly altered hierarchical declarations 411′.

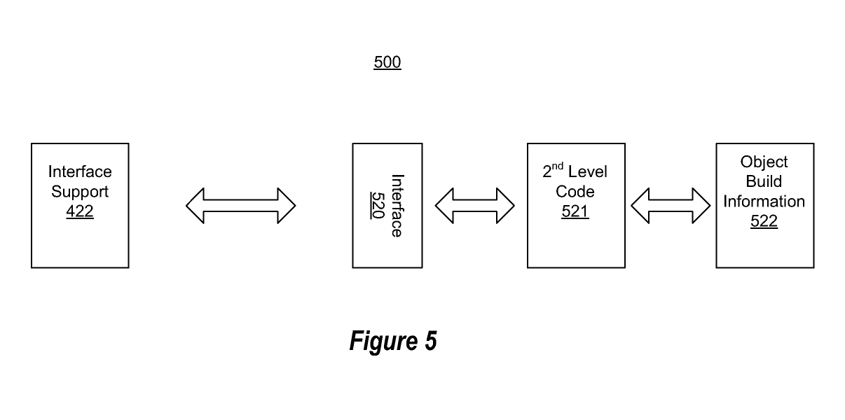

Although the system only interfaces through one interface (e.g., the system component 211 interfaces through the interface 220 with the application 221), the interface support code may recursively perform the method 300. As an example, the application 221 itself may not have access to the object build information for the application object. FIG. 5 illustrates how the object build information may be acquired recursively. For instance, perhaps the object to be built is not fully contained within the application 221, but instead relies on object build information defined by a library that is referenced by the application, but was not included directly in the application. In that case, the library may also be created in the manner described with respect to FIG. 4, and the interface support code 422 for the application would interact with an interface 520 with such second level code 521. That second level code would then access the object build information 522, and provide that object build information back to the interface support code 422. The interface support code 422 may then report that object build information, along with whatever other object build information it already had, back to the system component 211 through the interface 220.

Accordingly, the principles described herein provide a flexible mechanism for creating objects and perhaps associated relationships in memory, in which some of the objects may be system objects and some of the objects may be application objects, and where the object build information for the application objects may be provided directly by the application at runtime.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer program product comprising one or more computer storage media having thereon computer-executable instructions that are structured such that, when executed by one or more processors of a computing system, cause the computing system to perform the following:
an act of determining that an application object is to be created;
an act of determining that at least part of object build information to be used to create the application object is available at an application; and
an act of interfacing with the application through an interface to cause the application object to be created using the at least part of the object build information that is available at the application.

2. The computer program product in accordance with claim 1, wherein act of determining that the application object is to be created is performed in response to parsing of a hierarchically structured document that defines that the application object that is to be created.

3. The computer program product in accordance with claim 1, wherein the act of determining that the application object is to be created is performed in response to receiving a request from a parser that parses the hierarchically structured document that defines the application object that is to be created.

4. The computer program product in accordance with claim 3, wherein the parser is a XAML parser and the hierarchically structured document is a XAML document.

5. The computer program product in accordance with claim 1, wherein the act of interfacing comprises an act of receiving the at least part of the object build information from the application.

6. The computer program product in accordance with claim 1, wherein the at least part of the object build information comprises a type constructor for the application object.

7. The computer program product in accordance with claim 1, wherein the at least part of the object build information comprises a property accessor for the application object.

8. The computer program product in accordance with claim 1, wherein the at least part of the object build information comprises an event accessor for the application object.

9. The computer program product in accordance with claim 1, wherein the at least part of the object build information comprises a base type for type compatibility checks.

10. The computer program product in accordance with claim 1, wherein the at least part of the object build information comprises knowledge if the type is a collection to determine if a value is added to a property.

11. The computer program product in accordance with claim 1, wherein the computer-executable instructions are further structured such that, when executed by one or more processors of a computing system, cause the computing system to perform the following:
an act of determining that a system object is to be created; and
an act of creating the system object using object build information available outside of the application.

12. A computer-implemented method for creating an application object in a memory of a computing system, the method comprising:
an act of a system level of the computing system determining that an application object is to be created;
an act of the system determining that at least part of object build information to be used to create the application object is available at an application running on the computing system; and
an act of the system interfacing with the application through an interface to cause the application object to be created in the memory using the at least part of the object build information that is available at the application.

13. The method in accordance with claim 12, wherein act of determining that the application object is to be created is performed in response to the system parsing a hierarchically structured document that defines that the application object that is to be created.

14. The method in accordance with claim 12, wherein the act of determining that the application object is to be created is performed in response to receiving a request from a parser that parses the hierarchically structured document that defines the application object that is to be created.

15. The method in accordance with claim 12, wherein the act of interfacing comprises an act of receiving the at least part of the object build information from the application.

16. The method in accordance with claim 12, wherein the at least part of the object build information comprises a type constructor for the application object.

17. The method in accordance with claim 12, wherein the at least part of the object build information comprises a property accessor for the application object.

18. The method in accordance with claim 12, wherein the at least part of the object build information comprises an event accessor for the application object.

19. The method in accordance with claim 12, further comprising:
an act of determining that a system object is to be created; and
an act of creating the system object using object build information available outside of the application.

20. A computer-implemented method for creating an application object in a memory of a computing system, the method comprising:
an act of a system level of the computing system accessing a hierarchically structured document that defines at least one application object and act least one system object;
an act of the system parsing the hierarchically structured document to identify the application object and the system object;
an act of the system creating the system object in the memory using object build information available to the system outside of an application running on the computing system;
an act of the system determining that at least part of object build information to be used to create the application object is available at an application; and
an act of the system interfacing with the application through an interface to cause the application object to be created in the memory using the at least part of the object build information that is available at the application.
